(19) United States
(12) Patent Application Publication
(10) Pub. No.: US 2016/0216541 A1
(43) Pub. Date: Jul. 28, 2016

(54) LIQUID CRYSTAL DISPLAY DEVICE AND METHOD OF DRIVING THE SAME

(71) Applicants: Samsung Display Co., Ltd., Yongin-City (KR); Pusan National University Industry-University Cooperation, Geumjeong-gu (KR)

(72) Inventors: Taehyung HWANG, Seoul (KR); Seongsu LIM, Seoul (KR); Jungwook KIM, Busanjin-gu (KR); Taehoon YOON, Haeundae-gu (KR)

(21) Appl. No.: 14/949,427

(22) Filed: Nov. 23, 2015

(30) Foreign Application Priority Data
Jan. 27, 2015 (KR) 10-2015-0012976

(51) Int. Cl. G02F 1/137; G02F 1/1335; G02F 1/1343; G02F 1/1337

(52) U.S. Cl. CPC G02F 1/137; G02F 1/133784; G02F 1/1337; G02F 1/133528; G02F 1/134363; G02F 2001/133742; G02F 2001/13712

(57) ABSTRACT

Provided is a liquid crystal device including a first substrate, a lower electrode, a lower pattern electrode, a second substrate facing the first substrate, an upper electrode, and a liquid crystal layer. The lower electrode is disposed on the first substrate. The lower pattern electrode is insulated from the lower electrode and disposed on the lower electrode, and the lower pattern electrode includes branch parts. The upper electrode is disposed on the second substrate. The liquid crystal layer is disposed between the first substrate and the second substrate, and the liquid crystal layer includes liquid crystal molecules having negative dielectric anisotropy.

This U.S. non-provisional patent application claims the priority of and all the benefits accruing under 35 U.S.C. §119 of Korean Patent Application No. 10-2015-0012976, filed on Jan. 27, 2015, the entire contents of which are hereby incorporated by reference.

### BACKGROUND OF THE INVENTION

1. Field of Disclosure

The present disclosure herein relates to a liquid crystal display device and a method of driving the same, and more particularly, to a liquid crystal display device having an improved response speed and a method of driving the same.

2. Description of the Related Art

Liquid crystal display devices include two substrates and a liquid crystal layer disposed between the two substrates. Such a liquid crystal display device adjusts a transmittance of light emitted from a backlight unit by using a liquid crystal layer to display an image. The liquid crystal display devices may be classified into an in plane switching (IPS) mode, a vertical alignment (VA) mode, and a plane to line switching (PLS) mode according to a method for driving liquid crystal molecules of the liquid crystal layer.

### SUMMARY OF THE INVENTION

The present disclosure provides a liquid crystal display device having an improved response speed.

The present disclosure also provides a method of driving the liquid crystal display device, which is capable of improving a response speed of the liquid crystal display device.

Liquid crystal display devices include two substrates and a liquid crystal layer disposed between the two substrates. Such a liquid crystal display device adjusts a transmittance of light emitted from a backlight unit by using a liquid crystal layer to display an image. The liquid crystal display devices may be classified into an in plane switching (IPS) mode, a vertical alignment (VA) mode, and a plane to line switching (PLS) mode according to a method for driving liquid crystal molecules of the liquid crystal layer.

Embodiments of the inventive concept provide liquid crystal devices including a first substrate; a lower electrode disposed on the first substrate; a lower pattern electrode insulated from the lower electrode and disposed on the lower electrode, the lower pattern electrode including branch parts that are arranged on the lower electrode; a second substrate facing the first substrate; an upper electrode disposed on the second substrate; and a liquid crystal layer disposed between the first substrate and the second substrate, the liquid crystal layer including liquid crystal molecules having negative dielectric anisotropy.

In other embodiments of the inventive concept, methods of driving a liquid crystal display device that displays an image by using a liquid crystal layer adjusting a transmittance of light, the methods include providing liquid crystal molecules having negative dielectric anisotropy to the liquid crystal layer defined between the first substrate and the second substrate which face each other to align the liquid crystal molecules in a direction that is perpendicular to the first and second substrates; generating vertical electric fields between a lower electrode disposed on the first substrate and an upper electrode disposed on the second substrate to align the liquid crystal molecules in the first alignment state by using the vertical electric fields; and generating horizontal electric fields between the lower electrode and a lower pattern electrode disposed on the lower electrode and insulated from the lower electrode to align the liquid crystal molecules, which are aligned in the first alignment state, in the second alignment state by using the horizontal electric fields.

In some embodiments, the liquid crystal molecules may be aligned in the first alignment state to display a first gray scale, and the liquid crystal molecules may be aligned in the second alignment state to display a second gray scale that is different from the first gray scale.

In other embodiments, a transmittance of the light transmitting the liquid crystal layer may be maximized by the liquid crystal molecules aligned in the first alignment state to display the first gray scales. Also, the transmittance of the light transmitting the liquid crystal layer may be minimized by the liquid crystal molecules aligned in the second alignment state to display the second gray scale.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded perspective view of a liquid crystal display device according to an embodiment of the inventive concept;

FIG. 2 is a plan view illustrating one pixel of the liquid crystal display panel of FIG. 1;

FIG. 3A is a cross-sectional view of a surface taken along line I-I′ of FIG. 2;

FIG. 3B is a cross-sectional view of a surface taken along line II-IF of FIG. 2;

FIGS. 4A, 4B, 5A, 5B, 6A, and 6B are views illustrating a method of driving the liquid crystal display device described with reference to FIG. 1; and

FIG. 7 is a graph illustrating a response speed that is converted from a first alignment state into a second alignment state according to an embodiment of the inventive concept.

### DETAILED DESCRIPTION OF THE INVENTION

Hereinafter, exemplary embodiments will be described in detail with reference to the accompanying drawings. The objects, characteristics and effects of the inventive concept will become apparent with the detailed descriptions of the preferred embodiment and the illustrations of related drawings as follows. The invention may, however, be embodied in many different forms and should not be construed as being limited to the embodiments set forth herein. Rather, these embodiments are provided so that this disclosure will be thorough and complete, and will fully convey the scope of the inventive concept to those skilled in the art. Accordingly, the scope of the present disclosure is defined by the appended claims rather than the foregoing description and the exemplary embodiments described therein. In the following embodiments and drawings, like reference numerals in the drawings denote like elements.

It will be understood that although the terms first and second are used herein to describe various elements, these elements should not be limited by these terms. In the following description, it will be understood that when a layer (or film) is referred to as being “on” another layer or substrate, it can be directly on the other layer or substrate, or intervening layers may also be present.

Liquid crystal display devices include two substrates and a liquid crystal layer disposed between the two substrates. Such a liquid crystal display device adjusts a transmittance of light emitted from a backlight unit by using a liquid crystal layer to display an image. The liquid crystal display devices may be classified into an in plane switching (IPS) mode, a vertical alignment (VA) mode, and a plane to line switching (PLS) mode according to a method for driving liquid crystal molecules of the liquid crystal layer.

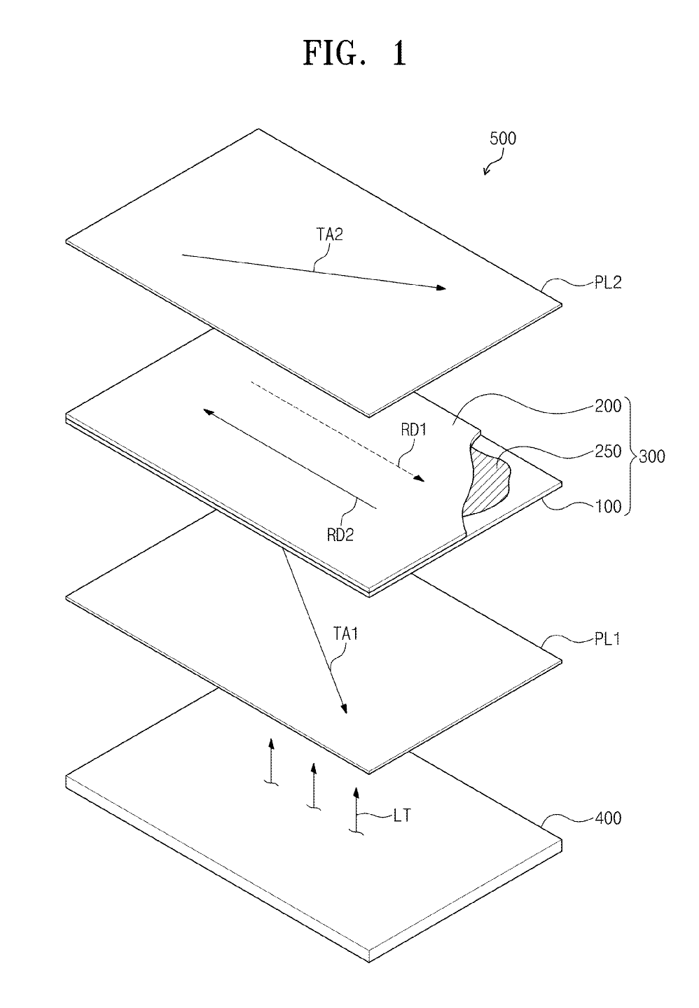

FIG. 1 is an exploded perspective view of a liquid crystal display device according to an embodiment of the inventive concept.

Referring to FIG. 1, a liquid crystal display device 500 includes a liquid crystal panel 300, a backlight unit 400, a first polarizing plate PL1, and a second polarizing plate PL2.

The backlight unit 400 is disposed below the liquid crystal panel 300. The backlight unit 400 includes a plurality of light sources (not shown) to provide output light LT to the liquid crystal panel 300.

Although the backlight unit 400 may have a direct-type structure that is realized by the plurality of light sources in this embodiment, the present disclosure is not limited thereto. For example, the backlight unit 400 may have an edge-type structure that includes a plurality of light sources and a light guide plate guiding light emitted from the plurality of light sources toward the liquid crystal display panel 300.

The liquid crystal display panel 300 is disposed above the backlight unit 400. The liquid crystal display panel 300 receives the output light LT from the backlight unit 400 to display an image.

The liquid crystal display panel 300 includes a first substrate 100, a second substrate 200, and a liquid crystal layer 250. The liquid crystal layer 250 is disposed between the first and second substrates 100 and 200, and the first substrate 100 is coupled to the second substrate 200 with the liquid crystal layer 250 therebetween. The liquid crystal layer 250 adjusts a transmittance of the output light LT, and thus an image may be displayed on the liquid crystal display panel 300 by the adjusted transmittance of the output light LT.

The first polarizing plate PL1 is disposed between the backlight unit 400 and the liquid crystal display panel 300 and attached to the first substrate 100. The second polarizing plate PL2 faces the first polarizing plate PL1 with the liquid crystal display panel 300 therebetween and is attached to the second substrate 200.

The first polarizing plate PL1 polarizes the output light LT. Also, the output light LT transmitted sequentially through the first polarizing plate PL1 and the liquid crystal layer 250 is polarized by the second polarizing plate PL2.

The first polarizing plate PL1 has a first transmission axis TA1, and the second polarizing plate PL2 has a second transmission axis TA2. The first transmission axis TA1 may be perpendicular to the second transmission axis TA2 on a plane in this embodiment. Although not shown, the first polarizing plate PL1 may have an absorption axis that is parallel to the second transmission axis TA2 on the plane, and the second polarizing plate PL2 may have an absorption axis that is parallel to the first transmission axis TA1 on the plane.

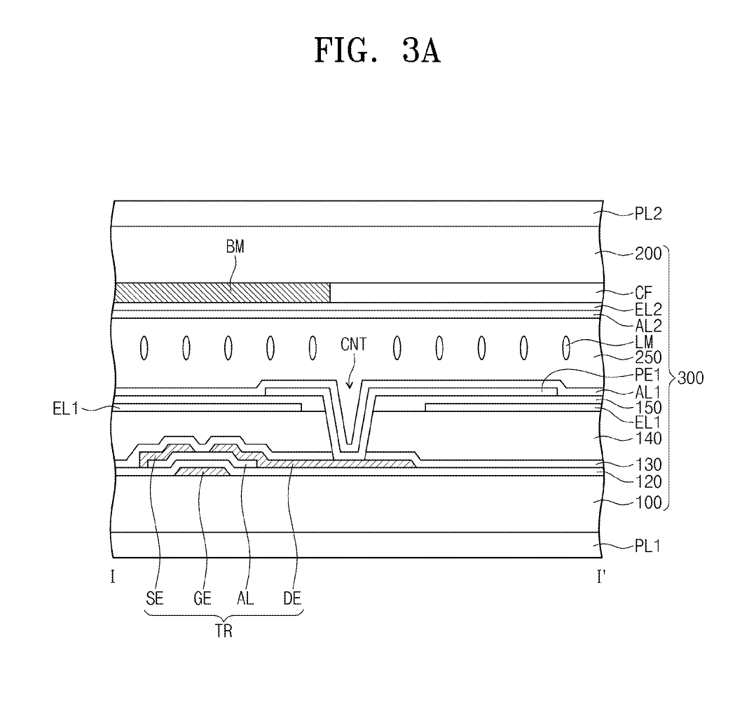

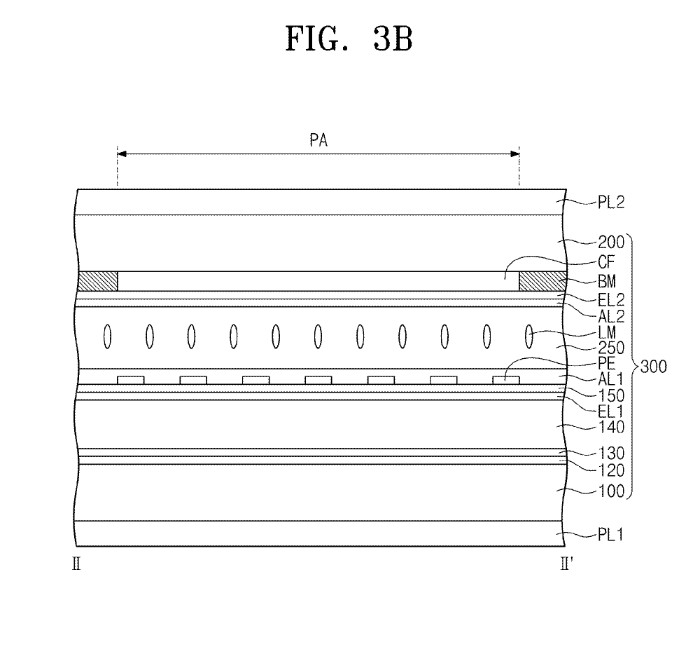

In this embodiment, a first alignment layer (see reference symbol AL1 of FIG. 3B) aligning liquid crystal molecules (see reference symbol LM of FIG. 3B) of the liquid crystal layer 250 may be disposed on the first substrate 100, and a second alignment layer (see reference symbol AL2 of FIG. 3A) aligning the liquid crystal molecules may be disposed on the second substrate 200. Also, a first rubbing direction RD1 may be defined on the first alignment layer, and a second rubbing direction RD2 may be defined on the second alignment layer. The first rubbing direction RD1 may be a direction that is opposite to or the same as the second rubbing direction RD2 in this embodiment.

In this embodiment, an angle between the first rubbing direction RD1 or the second rubbing direction RD2 and each of the first transmission axis TA1 and the second transmission axis TA2 may be about 45 degrees or about 135 degrees.

Also, the first and second rubbing directions RD1 and RD2 may be defined by a rubbing process that is performed on the first and second alignment layers in this embodiment. In another embodiment, light alignment directions may be defined on the first and second alignment layers by applying a light alignment process to the first and second alignment layers, and the light alignment directions may be substituted for the first and second rubbing directions RD1 and RD2.

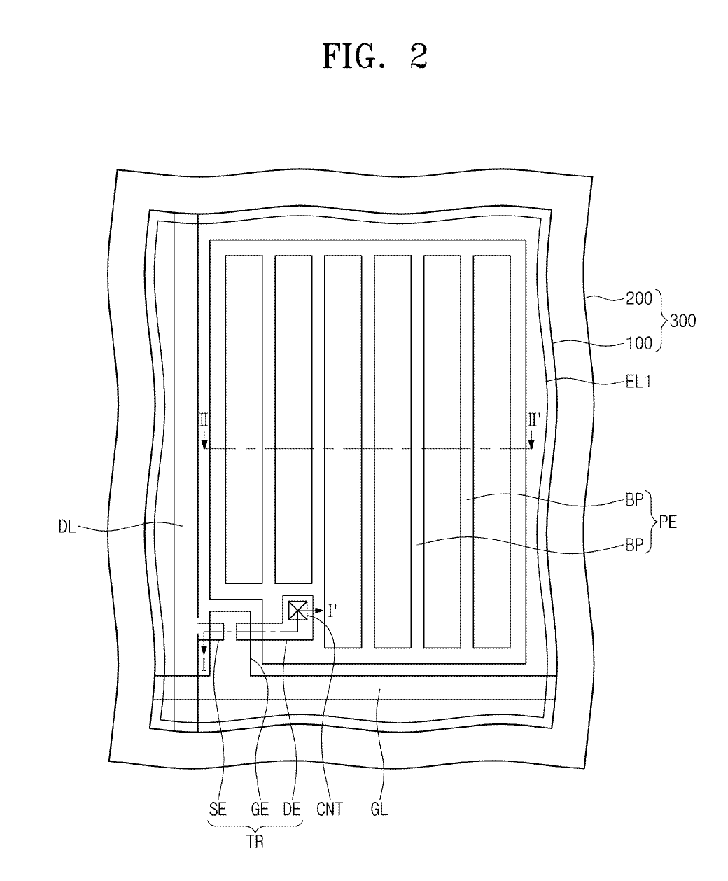

FIG. 2 is a plan view illustrating one pixel of the liquid crystal display panel 300 of FIG. 1, FIG. 3A is a cross-sectional view of a surface taken along ling I-I′ of FIG. 2, and FIG. 3b is a cross-sectional view of a surface taken along II-II′ of FIG. 2.

Referring to FIGS. 2, 3A, and 3B, although the liquid crystal display panel 300 includes a plurality of pixels, one pixel, which is disposed on a pixel area PA, of the plurality of pixels is illustrated in FIG. 2 as an example, and illustration and description for other pixels will be omitted.

A gate line GL, a data line DL, a thin film transistor TR, a lower electrode EL1, a lower pattern electrode PE, and a first alignment layer AL1 are disposed on the first substrate 100.

The first substrate 100 may transmit light like a glass substrate. The gate line GL is disposed on the first substrate 100 to transmit a gate signal. A first insulation layer 120 covers the gate line GL, and the data line DL is disposed on the first insulation layer 120. The data line DL is insulated from the gate line GL by the first insulation layer 120 to transmit a data signal.

The gate line GL may intersect with the data line DL on the plane, and the gate line GL may extend in one direction to be perpendicular to the data line DL in this embodiment. In another embodiment, the gate line GL may extend in two directions that are perpendicular to each other to have a shape that is continuously bent in a zigzag form.

The thin film transistor TR is electrically connected to the lower pattern electrode PE to switch a driving signal applied to the lower pattern electrode PE. In this embodiment, the thin film transistor TR includes a gate electrode GE, an active layer AL, a source electrode SE, and a drain electrode.

The gate electrode GE is disposed on the first substrate 100 and branched from the gate line GL. The active layer AL includes a semiconductor material and is disposed on the first insulation layer 120. The active layer AL overlaps the gate electrode GE. The source electrode SE is branched from the data line DL to overlap the active layer AL, and the drain electrode DE is spaced apart from the source electrode SE to overlap the active layer AL.

A second insulation layer covers the thin film transistor TR and the data line DL, and a third insulation layer 140 is disposed on the second insulation layer 130 to planarize a portion of the first substrate 100 on which the thin film transistor TR is disposed.

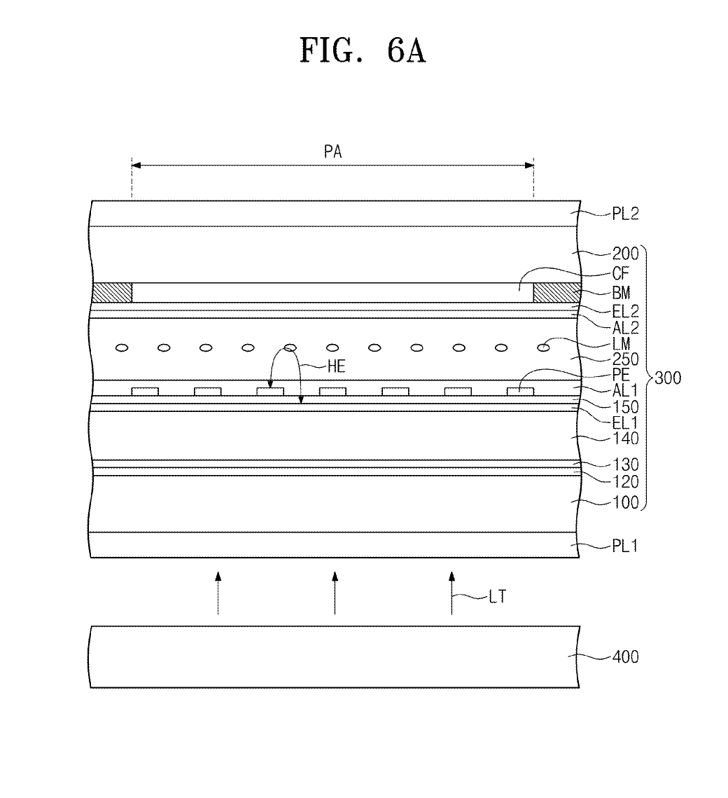

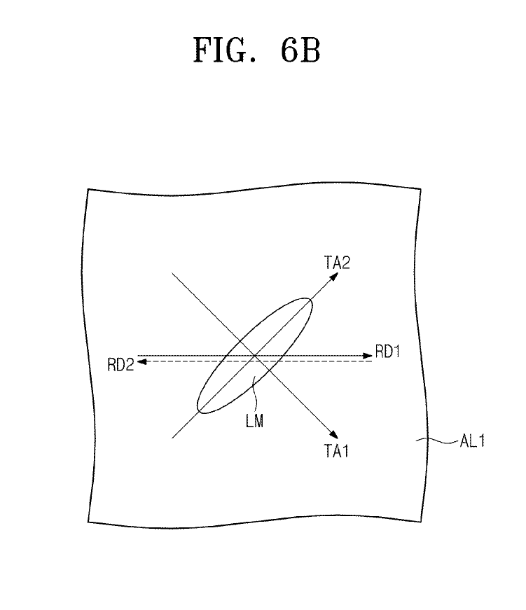

The lower electrode EL1 is disposed on the third insulation layer 140, and a fourth insulation layer 150 is disposed on the lower electrode ELL Accordingly, when a common voltage or a reference voltage is applied to the lower electrode EL1, and a driving signal is applied to the lower pattern electrode PE, horizontal electric fields (see reference symbol HE of FIG. 6A) may be generated between the lower electrode EL1 and the lower pattern electrode PE. The horizontal electric fields align the liquid crystal molecules to the second alignment state, and its detailed description will be described later with reference to FIGS. 6A and 6B.

The lower pattern electrode PE is electrically connected to the drain electrode DE of the thin film transistor TR through a contact hole CNT passing through the second and third insulation layers 130 and 140, and the lower pattern electrode PE is disposed on the pixel area PA. In this embodiment, the lower pattern electrode PE includes branch parts BP disposed on the lower electrode EL1.

The second substrate 200 may transmit light like a glass substrate. A light blocking layer BM, a color filter CF, an upper electrode EL2, and a second alignment layer AL2 are disposed on the second substrate 200.

The color filter CF is disposed on the second substrate 200 to correspond to the pixel area PA. The color filter CF filters the output light (see reference symbol LT of FIG. 1) outputted from the backlight unit (see reference numeral 400 of FIG. 1) to generate color light. Also, the light blocking layer BM is disposed on the second substrate 200 to correspond to the rest area except for the pixel area PA, thereby blocking the output light. For example, the light blocking layer BM may be disposed on the second substrate 200 to correspond to an area where the thin film transistor TR is disposed.

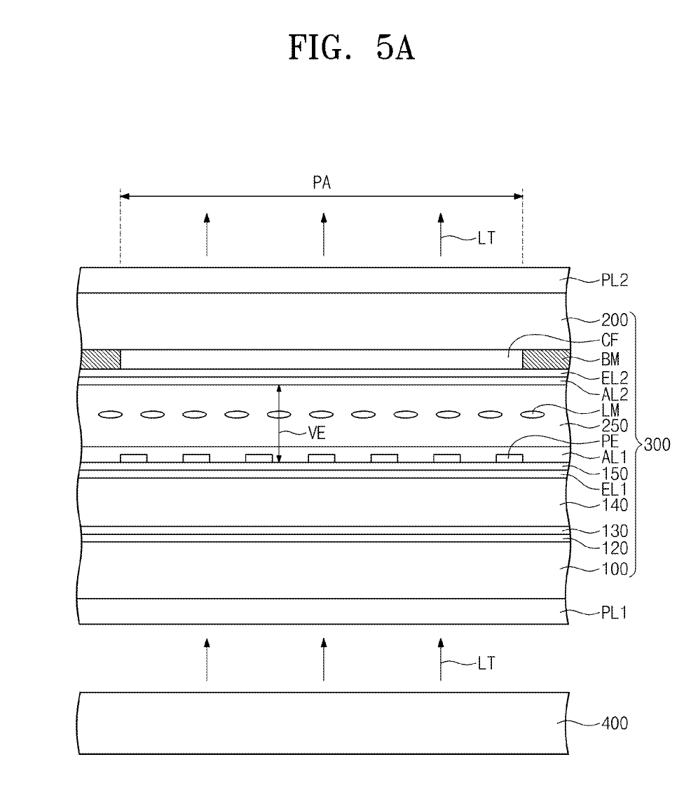

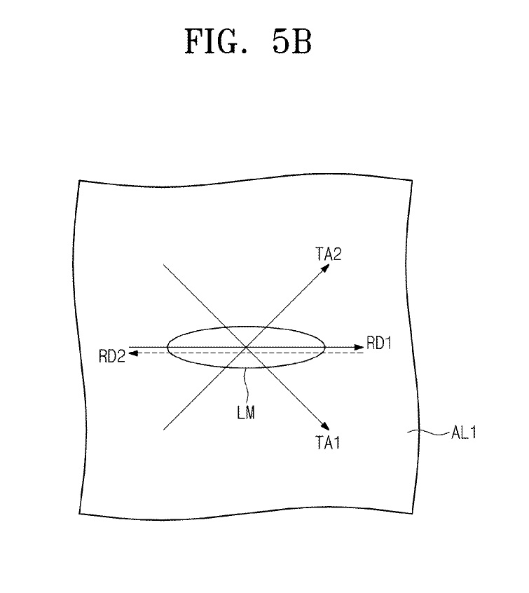

The upper electrode EL2 is disposed on the light blocking layer BM and the color filter CF. The common voltage and the reference voltage may be applied to the upper electrode EL2. Accordingly, vertical electric fields (see reference symbol VE of FIG. 5A) may be generated between the upper electrode EL2 and the lower electrode EL1 or between the upper electrode EL2 and the lower pattern electrode PE. The vertical electric fields align the liquid crystal molecules to the first alignment state, and its detailed description for this will be described later with reference to FIGS. 5A and 5B.

The first alignment layer AL1 is disposed on the lower pattern electrode PE, and the second alignment layer AL2 is disposed on the second electrode EL2. When any electric fields are not applied to the liquid crystal molecules LM, the first and second alignment layers AL1 and AL2 align the liquid crystal molecules LM in a direction perpendicular to the first and second substrates 100 and 200.

The liquid crystal layer 250 includes liquid crystal molecules LM having negative dielectric anisotropy. Accordingly, the liquid crystal molecules may be aligned so that a director of each of the liquid crystal molecules LM is aligned perpendicular to a direction of the vertical electric field (see reference symbol VE of FIG. 5A) or the horizontal electric field (see reference symbol HE of FIG. 6A).

Hereinafter, a driving method of displaying a gray scale of the liquid crystal display device including the liquid crystal display panel 300 will be explained as follows.

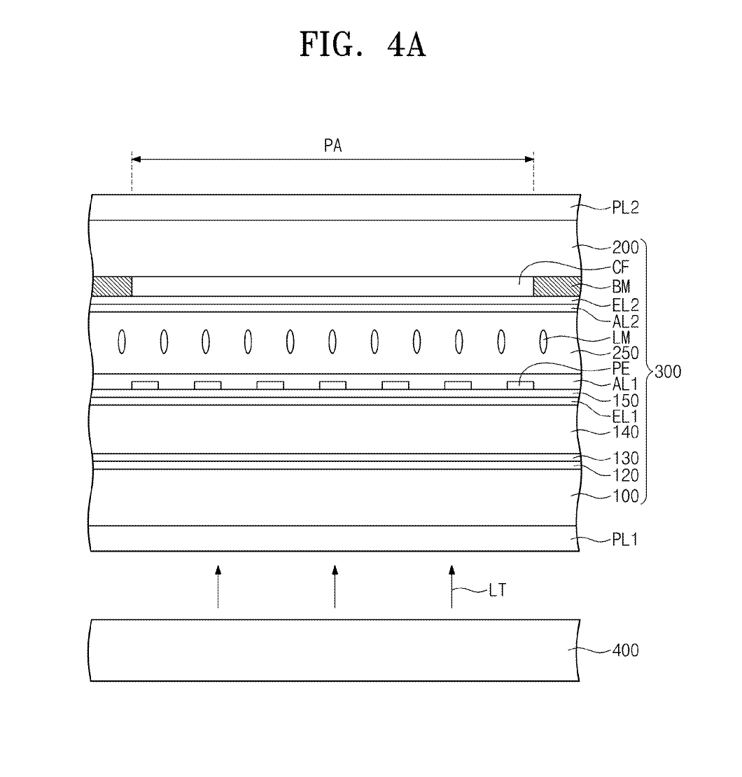

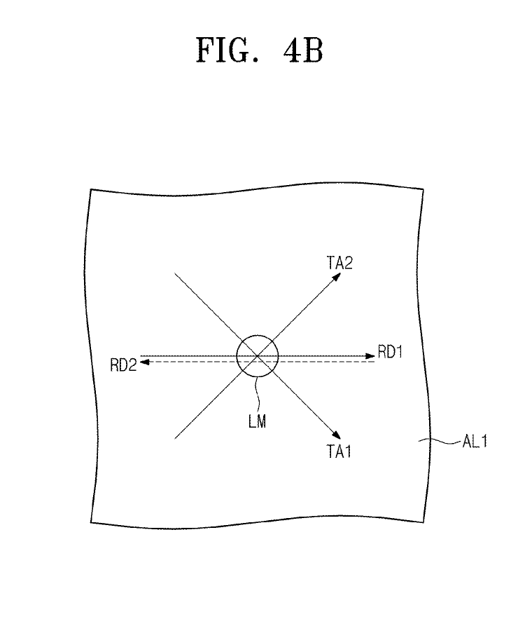

FIGS. 4A, 4B, 5A, 5B, 6A, and 6B are views illustrating a method of driving the liquid crystal display device described with reference to FIG. 1. In more detail, each of FIGS. 4A, 5A, and 6A illustrates a cross-section of the liquid crystal display device in each driving process, and each of FIGS. 4B, 5B, and 6B is a plan view of one of liquid crystal molecules LM disposed on the first alignment layer in each driving process.

Referring to FIGS. 4A and 4B, an initial alignment state of the liquid crystal molecule LM is illustrated. In more detail, in the initial alignment state of the liquid crystal molecule LM, the liquid crystal molecule LM may not be affected by any electric fields when electric fields between the lower electrode EL1, the lower pattern electrode PE, and the upper electrode EL2 are turned off. As a result, the liquid crystal molecule LM may be aligned perpendicular to each of the first alignment layer AL1 and the second alignment layer AL2.

Accordingly, a phase of the output light LT is not changed while the output light LT outputted from the backlight unit 400 is transmitted through the liquid crystal layer 250. As a result, the first transmission axis TA1 of the first polarizing plate PL1 is perpendicular to the second transmission axis TA2 of the second polarizing plate PL2. In other words, since the first transmission axis TA1 is parallel to an adsorption axis of the second polarizing plate PL2, the output light LT is blocked by the second polarizing plate PL2 after the output light LT sequentially transmits through the first polarizing plate PL1 and the liquid crystal layer 250.

Accordingly, in the initial alignment state of the liquid crystal molecule LM, a transmittance of the output light LT transmitted though the pixel area PA of the pixel display panel 300 may be minimized to display a first gray scale on the pixel area PA. In this embodiment, the first gray scale may be displayed with a black color.

Referring to FIGS. 5A and 5B, a first alignment state of the liquid crystal molecule LM is illustrated. In more detail, in the first alignment state of the liquid crystal molecule LM, vertical electric fields VE between the lower electrode EL1 and the upper electrode EL2 are generated. Accordingly, the liquid crystal molecule LM having negative dielectric anisotropy is aligned parallel to each of the first and second substrates 100 and 200 by the vertical electric fields VE.

Also, in the first alignment state of the liquid crystal molecule LM, the liquid crystal molecule LM is aligned so that a director or a long axis of the liquid crystal molecule LM is aligned parallel to the first rubbing direction RD1 of the first alignment layer AL1 or the second rubbing direction RD2 of the second alignment layer AL2.

Accordingly, as described above, when an angle between the first rubbing direction RD1 or the second rubbing direction RD2 and each of the first and second transmission axes TA1 and TA2 may be about 45 degrees or about 135 degrees, a transmittance of the output light LT transmitted through the pixel area PA of the liquid crystal display panel 300 may be maximized.

As a result, in the first alignment state of the liquid crystal molecule LM, the output light LT may sequentially transmit through the first polarizing plate PL1, the liquid crystal layer 250, and the second polarizing plate PL2, and then a second gray scale may be displayed on the pixel area PA by the output light outputted through the pixel area PA. The second gray scale may be different from the first gray scale that is described with reference to FIGS. 5A and 5B, and the second gray scale may be displayed with a white color in this embodiment.

Referring to FIGS. 6A and 6B, a second alignment state of the liquid crystal molecule LM is illustrated. In the second alignment state of the liquid crystal molecule LM, the vertical electric fields (see reference symbol VE of FIG. 5A) are turned off, and the horizontal electric fields HE between the lower electrode EL1 and the lower pattern electrode PE are generated. Thus, the liquid crystal that is aligned in the first alignment state described with reference to FIGS. 5A and 5B is aligned in the second alignment state by the horizontal electric fields HE.

In the second alignment state of the liquid crystal molecule LM, the liquid crystal molecule LM is aligned so that a director or a long axis of the liquid crystal molecule LM is disposed parallel to the first transmission axis TA1 or the second transmission axis TA2. Accordingly, in the second alignment state of the liquid crystal molecule LM, a transmittance the output light LT transmitted though the pixel area PA of the pixel display panel 300 may be minimized to display a third gray scale on the pixel area PA of the liquid crystal display panel 300. In this embodiment, the third gray scale may be substantially same as the first gray scale (the first gray scale is the gray scale resulted when no electric field is applied) that is previously explained with reference to FIGS. 4A and 4B. For example, the third gray scale may be displayed with the black color, like the first gray scale.

Unlike the embodiment of the inventive concept that the vertical electric fields VE may change from the turn-on state into the turn-off state to convert the gray scale displayed on the pixel area PA from the second gray scale into the first gray scale. In this embodiment of the inventive concept, however, since the vertical electric fields VE change from the ON state into the OFF state, and simultaneously, the horizontal electric fields HE are turned on (ON state) to convert the gray scale displayed on the pixel area PA into the third gray scale that is the substantially same as the first gray scale, a response speed at which the gray scale is converted on the pixel area PA may increase.

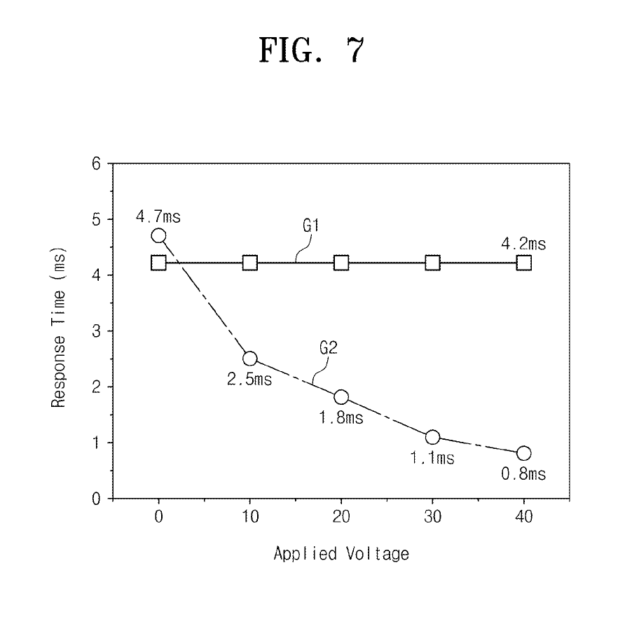

FIG. 7 is a graph illustrating a response speed at which the liquid crystal molecule is converted from the first alignment state into the second alignment state according to a comparative example and an embodiment of the inventive concept.

Referring to FIG. 7, a first graph G1 according to a comparative example of the inventive concept illustrates a response speed at which the liquid crystal molecule is converted from the first alignment state into the second alignment state according to the intensity of an applied voltage in the liquid crystal display device that operates in a general vertical alignment mode. In more detail, when the liquid crystal molecule is converted from the first alignment state into the second alignment state, the liquid crystal molecule returns to the initial alignment state according to the turn-off of the vertical electric fields (see reference symbol VE of FIG. 5A) without the horizontal electric fields (see reference symbol HE of FIG. 6A) in the comparative example of the inventive concept.

A second graph G2 according to an embodiment of the inventive concept illustrates a response speed at which the liquid crystal molecule is converted from the first alignment state into the second alignment state according to the intensity of an applied voltage. In this embodiment, the applied voltage represents a voltage applied to the lower pattern electrode (see reference symbol PE of FIG. 6A). When the applied voltage is applied to the lower pattern electrode, the lower electrode (see reference symbol EL1 of FIG. 6A) may have a reference voltage of about 0 V, and thus the horizontal electric fields (see reference symbol HE of FIG. 6A) previously explained with reference to FIG. 6A may be generated.

Referring to the first graph G1, the response speed is constant to about 4.2 millisecond (ms) regardless of the intensity of the applied voltage. That is, in the comparative example of the inventive concept, since the response speed is defined as a time that is taken to turn off the vertical electric fields that align the liquid crystal molecule in the first alignment state and to allow the liquid crystal molecule to return to the initial alignment state, the response speed may have a constant value regardless of the intensity of the applied voltage.

Referring to the first graph G2, the response speed may decrease as the intensity of the applied voltage increases. In more detail, the response speed may be about 4.7 ms when the applied voltage is about 0 V. However, the response speed may be reduced to about 2.5 ms when the applied voltage is about 10 V, and the response speed may be reduced up to about 0.8 ms when the applied voltage is about 40 V.

According to the result shown in the second graph G2, the response speed may be easily reduced when the intensity of the applied voltage increases to increase the intensity of the horizontal electric field because the liquid crystal molecule aligned in the first alignment state is aligned in the second alignment state by using the horizontal electric fields generated by the applied voltage in an embodiment of the inventive concept.

According to the embodiment of the inventive concept, a portion of the three electrodes of the liquid crystal display panel may be selectively driven to independently generate the vertical electric fields and horizontal electric fields, which act on the liquid crystal molecules. Therefore, the liquid crystal molecules may be aligned by using the vertical electric fields to display the gray scale. Also, the liquid crystal molecules may be aligned by using the horizontal electric fields to quickly display the other gray scale.

Although a preferred embodiment of the inventive concept has been disclosed, various changes and modifications may be made thereto by one skilled in the art without departing from the scope and spirit of the invention as set forth in the appended claims. Therefore, the detailed description of the present invention does not intend to limit the present invention to the disclosed embodiments. Further, the scope of the present invention should be defined by the following claims.

What is claimed is:

1. A liquid crystal display device, comprising:
a first substrate;
a lower electrode disposed on the first substrate;
a lower pattern electrode insulated from the lower electrode and disposed on the lower electrode, and the lower pattern electrode comprising branch parts that are arranged on the lower electrode;
a second substrate facing the first substrate;
an upper electrode disposed on the second substrate; and
a liquid crystal layer disposed between the first substrate and the second substrate, the liquid crystal layer comprising liquid crystal molecules having negative dielectric anisotropy.

2. The liquid crystal display device of claim 1, wherein horizontal electric fields are defined between the lower electrode and the lower pattern electrode, and
wherein vertical electric fields are defined between the lower electrode and the upper electrode.

3. The liquid crystal display device of claim 2, further comprising:
a first alignment layer disposed on the first substrate; and
a second alignment layer disposed on the second substrate,
wherein, when the horizontal electric fields and the vertical electric fields are turned off, the liquid crystal molecules are aligned perpendicular to each of the first and second substrates by the first and second alignment layers.

4. The liquid crystal display device of claim 3, further comprising:
a first polarizing plate attached to the first substrate, the first polarizing plate comprising a first transmission axis; and
a second polarizing plate attached to the second substrate, the second polarizing plate comprising a second transmission axis that is perpendicular to the first transmission axis on a plane,
wherein the liquid crystal molecules are aligned in a first alignment state, and the liquid crystal molecules are parallel to the first and second substrates controlled by the vertical electric fields in the first alignment state, and
a director or a long axis of each of the liquid crystal molecules that are aligned in the first alignment state is configured to intersect at a point of the first transmission axis and to intersect at a point of the second transmission axis on the plane.

5. The liquid crystal display device of claim 4, wherein a director of each of the liquid crystal molecules that are aligned to the first alignment state forms an angle of about 45 degrees or about 135 degrees with respect to each of the first and second transmission axes on the plane.

6. The liquid crystal display device of claim 4, wherein a director of each of the liquid crystal molecules that are aligned in the first alignment state is parallel to a rubbing direction that is defined on the first alignment layer or the second alignment layer.

7. The liquid crystal display device of claim 4, wherein the liquid crystal molecules are aligned in a second alignment state by the horizontal electric fields, and
a director of each of the liquid crystal molecules that are aligned in the second alignment state is parallel to the first transmission axis or the second transmission axis on the plane.

8. The liquid crystal display device of claim 1, wherein the upper electrode is configured to be turned off and the lower pattern electrode being configured to be simultaneously turned on.

9. A method of driving a liquid crystal display device that displays an image by using a liquid crystal layer adjusting a transmittance of light, the method comprising:
providing liquid crystal molecules having negative dielectric anisotropy to the liquid crystal layer defined between the first substrate and the second substrate which face each other to align the liquid crystal molecules in a direction that is perpendicular to the first and second substrates;
generating vertical electric fields between a lower electrode disposed on the first substrate and an upper electrode disposed on the second substrate to align the liquid crystal molecules in a first alignment state by using the vertical electric fields; and
generating horizontal electric fields between the lower electrode and a lower pattern electrode disposed on the lower electrode and insulated from the lower electrode to align the liquid crystal molecules, which are aligned in the first alignment state, in a second alignment state by using the horizontal electric fields.

10. The method of claim 9, wherein the liquid crystal molecules are aligned perpendicular to the first and second substrates to display a first gray scale, the liquid crystal molecules are aligned in the first alignment state to display a second gray scale that is different from the first gray scale, and the liquid crystal molecules are aligned in the second alignment state to display a third gray scale that is substantially same as the first gray scale.

11. The method of claim 10, further comprising:
minimizing a transmittance of the light transmitting the liquid crystal layer to display the first and third gray scales, and
maximizing the transmittance of the light transmitting the liquid crystal layer to display the second gray scale.

12. The method of claim 9, further comprising turning off the horizontal electric fields when the vertical electric fields are turned on.

13. The method of claim 9, further comprising turning on the horizontal electric fields when the vertical electric fields are turned off.

14. The method of claim 9, wherein, when the liquid crystal molecules are aligned in the first alignment state, the liquid crystal molecules are aligned parallel to the first and second substrates by the vertical electric fields.

15. The method of claim 14, further comprising, when the liquid crystal molecules are aligned in the first alignment state, a director of each of the liquid crystal molecules is parallel to a rubbing direction that is defined on a first alignment layer of the first substrate or a second alignment layer of the second substrate.

16. The method of claim 9, further comprising, when the liquid crystal molecules are aligned in the second alignment state, a director of each of the liquid crystal molecules is parallel to a first transmission axis of a first polarizing plate attached to the first substrate or a second transmission axis of a second polarizing plate attached to the second substrate.

17. The method of claim 9, further comprising aligning the liquid crystal molecules perpendicular to the first and second substrates when each of the horizontal electric fields and the vertical electric fields is turned off.

18. A method of driving a liquid crystal display device that displays an image by using a liquid crystal layer adjusting a transmittance of light, the method comprising:
providing liquid crystal molecules having negative dielectric anisotropy to the liquid crystal layer defined between the first substrate and the second substrate which face each other to align the liquid crystal molecules in a direction that is perpendicular to the first and second substrates;
generating vertical electric fields between a lower electrode disposed on the first substrate and an upper electrode disposed on the second substrate to align the liquid crystal molecules in a first alignment state by using the vertical electric fields; and
discontinuing the generating the vertical electric fields and simultaneously initiating horizontal electric fields between the lower electrode and a lower pattern electrode disposed on the lower electrode and insulated from the lower electrode to align the liquid crystal molecules, which are aligned in the first alignment state, in a second alignment state by using the horizontal electric fields.
